(19) United States
(12) Patent Application Publication
(10) Pub. No.: US 2013/0218938 A1
(43) Pub. Date: Aug. 22, 2013

(54) FLOATING-POINT ADDER WITH OPERAND SHIFTING BASED ON A PREDICTED EXPONENT DIFFERENCE

(71) Applicant: Qualcomm Incorporated, (US)

(72) Inventors: Kenneth Alan Dockser, Cary, NC (US); Pathik Sunil Lall, Raleigh, NC (US)

(73) Assignee: Qualcomm Incorporated, San Diego, CA (US)

(21) Appl. No.: 13/768,698

(22) Filed: Feb. 15, 2013

Related U.S. Application Data
(60) Provisional application No. 61/599,964, filed on Feb. 17, 2012.

(51) Int. Cl. G06F 7/485

(52) U.S. Cl. CPC G06F 7/485
USPC 708/209

(57) ABSTRACT

Provided are a floating-point adder and methods for implementing a floating-point adder with operand shifting based on a predicted exponent difference when performing an effective subtraction on normal or subnormal numbers. In an aspect, two least significant bits (LSBs) of a first floating-point operand's exponent are compared with two LSBs of a second floating-point operand's exponent to estimate a difference between the two exponents. A first shift of up to one of the first and the second operands is performed, based on the estimated difference. A prospective result is then produced by subtracting the first operand and the second operand. Contemporaneously, one of the first operand's exponent and the second operand's exponent is subtracted from the other of the first operand's exponent and the second operand's exponent to determine if the exponents actually differ by one or less. If the first operand's exponent and the second operand's exponent differ by one or less, the prospective result is provided as the raw difference of the operands.

### CLAIM OF PRIORITY UNDER 35 U.S.C. §119

The present application for patent claims priority to U.S. Provisional Patent Application No. 61/599,964 entitled “FLOATING-POINT ADDER WITH OPERAND SHIFTING BASED ON A PREDICTED EXPONENT DIFFERENCE”, filed Feb. 17, 2012, and assigned to the assignee hereof and hereby expressly incorporated by reference herein.

### FIELD OF DISCLOSURE

This disclosure relates generally to electronics, and more specifically, but not exclusively, to a floating-point adder with operand shifting based on a predicted exponent difference and methods for implementing a floating-point adder with operand shifting based on a predicted exponent difference.

### BACKGROUND

Digital technologies represent numbers in either a fixed-point format or a floating-point formatA floating-point number comprises a fixed-point mantissa ('mant) multiplied by a base (base) that is raised to an integer exponent (exp). A normalized (also called normal) mantissa consists of an integer bit of value one, followed by a binary point and then a fraction. A subnormal mantissa consists of an integer bit of zero followed by a binary point and a non-zero fraction. The integer bit is typically not explicitly encoded; instead, the integer bit is implicitly encoded by the exponent, where a reserved exponent of zero indicates that the integer bit is zero. In the floating-point number, the value of the exponent determines a number of bit positions and a direction that the binary point in the mantissa should be shifted to realize a decoded numerical value. The exponent is conventionally encoded by adding a bias to the exponent (e.g., as specified in the IEEE 754 floating-point standard). The encoding allows for reserved values of all ones or all zeros. The floating-point number also includes a sign bit (sign). Thus, a floating-point value can be expressed as (−1)^{sign}×mant×base^{exp}. As an example, a binary analog to scientific notation in a base ten system is a floating-point number created by multiplying the mantissa by a base of two that is raised to an integer exponent. The floating-point format can be used to express a wide range of values and ease manipulation during some arithmetic operations.

In conventional floating point adders, addition and subtraction are performed through a series of steps such as: alignment shifting, adding or subtracting, normalization shifting, rounding, and/or special case handling.

In order to perform the alignment shifting, it is necessary to subtract the two exponents to determine which is smaller and by how much. This difference is used to determine how to align the two mantissas relative to each other. The alignment results in the mantissa with the smaller exponent being effectively shifted right relative to the other mantissa. The alignment can be performed by shifting this mantissa to the right or shifting the mantissa with the larger exponent to the left, ln either case, the shift amount is the difference of the true exponents.

When subtraction is performed, the mantissa effectively shifted to the right is treated as the subtrahend, and is subtracted from the larger mantissa which is treated as the minuend. When the exponents are equal, the assignment of subtrahend and minuend is arbitrary. In such a case, if the difference is negative, the results of the subtraction are corrected so that a raw output of the adder is positive.

After the addition or subtraction, the raw output is normalized to produce an intermediate result. Normalization is a process of shifting the raw output and adjusting the raw output's exponent so that either the integer bit is a one, or a smallest exponent is reached that prevents the mantissa from being effectively shifted left any further.

After the normalization, the intermediate result is rounded and checked for exceptional conditions such as overflow to produce a rounded result. A final result is produced from the rounded result or a forced result from exception handling logic.

It has long been known that when adding or subtracting floating-point numbers, at most one of the alignment shift and normalization shift needs to shift more than one place. Implementations can take advantage of this fact to reduce a depth of logic needed for addition or subtraction, thereby reducing latency of such an operation. The challenge has been to be able to perform the exponent subtraction fast enough to be able to choose the proper path, while staying within cycle time constraints of the design.

Accordingly, there are long-felt industry needs for methods and apparatus that improve upon conventional methods and apparatus, including a floating-point adder with operand shilling based on a predicted exponent difference.

### SUMMARY

This summary provides a basic understanding of some aspects of the present teachings. This summary is not exhaustive in detail, and is neither intended to identify all critical features, nor intended to limit the scope of the claims.

Exemplary methods and apparatus for subtracting a first operand and a second operand in a floating point adder are provided. The subtraction specified herein is not limited to explicit subtraction instructions, but also includes effective subtraction wherein two operands of different sifIns are added. In an exemplary method, the first and the second operands, each of which has a respective exponent, are received. At least one of the first operand and the second operand can be subnormal. At least one of the first operand and the second operand can be normal. Two least significant bits (LSBs) of the first operand's exponent are compared with two LSBs of the second operand's exponent to estimate if the first operand's exponent is larger than the second operands exponent (e.g., by one), the second operand's exponent is larger than the first operand's exponent (e.g., by one), the first operand's exponent equals the second operand's exponent, or the LSBs of the first and second operands' exponents are inconsistent with the LSBs of the first and second operands' exponents differing by one. A first shift of up to one of the first and the second operands may be performed, based on the results of the comparing. A prospective result is produced by subtracting the first mantissa and the second mantissa after the first shift. The mantissa with the smaller exponent is the subtrahend and the mantissa with the larger exponent is the minuend. When the exponents are equal, either of the operands can be subtracted from the other; if the result is negative, a correction is performed. All bits of one of the first operand's exponent and the second operand's exponent are subtracted from all bits of the other of the first operand's exponent and the second operand's exponent to determine the true exponent difference. The subtracting is performed contemporaneously with the comparing, the performing the first shift, and the producing the prospective result. If the first operand's exponent and the second operand's exponent differ by one or less, the prospective result is provided as a raw difference. If the first operand's exponent and the second operand's exponent do not differ by one or less, then a second shift of one of the first and the second operands is determined from all bits of the first and the second operands exponents, the second shill of one of the first and the second operands is performed, and the first operand and the second operand are subtracted, after the second shift, to produce the raw difference. The second shift determination can be based on the subtraction of the exponents which determines the true exponent difference. That is, for cases where the true exponent difference is greater than one, the alignment shift is based on the true exponent difference computed in the previously described exponent subtraction. The shift amount determination employs saturation logic to limit the maximum shill amount when the true exponent difference indicates that the subtrahend is aligned to the right of the minuend's fraction bits, guard bit, round bit, and first sticky bit. Saturating and limiting the shift amount allows for minimal shifter logic which saves time and power. Optionally, the comparing and the performing the first shift of one of the first and the second operands occurs during the full exponent subtraction process.

Optionally, the subtraction of the two mantissas treats the mantissa with the larger exponent as the minuend and the mantissa with the smaller exponent as the subtrahend. When the exponents are equal the choice of minuend and subtrahend is arbitrary. Also, if the exponents are equal and the difference of the mantissas is negative, a two's complement process can be performed on the difference in a downstream adder that is normally used when the exponents differ by more than one. Furthermore, when the LSBs of the exponents are inconsistent with a difference of one or zero, the speculative subtraction is blocked to save energy.

In an aspect, when at least one of the first operand and the second operand is subnormal, the first shift produces relative right alignment of the first operand to the second operand by using the following equation, where “Ea” indicates the first operand's exponent, “Eb” indicates the second operand's exponent, and subnormal exponents use reserved encoding of all zeros:

$$( ( \sim Eb [ 1 ] \& Ea [ 1 ] \& Ea [ 0 ] ) \vert \\ ( Eb [ 1 ] \& Eb [ 0 ] \& Ea [ 1 ] \& \sim Ea [ 0 ] ) \vert \\ ( Eb [ 1 ] \& \sim Eb [ 0 ] \& \sim Ea [ 1 ] ) ) \vert \\ ( ( \sim Eb [ 1 ] \& Eb [ 0 ] \& \sim Ea [ 1 ] \& \sim Ea [ 0 ] ) \& \vert Ea [ msb \text{:} 2 ] ) ; .$$

In a further aspect, when at least one of the first operand and the second operand is subnormal, the first shift produces relative right alignment of the second operand to the first operand by using the following equation, where “Ea” indicates the first operands exponent, “Eb” indicates the second operands exponent, and subnormal exponents use reserved encoding of all zeros:

$$( ( \sim Eb [ 1 ] \& Eb [ 0 ] \& Ea [ 1 ] ) \vert \\ ( Eb [ 1 ] \& Eb [ 0 ] \& \sim Ea [ 1 ] ) \vert \\ ( Eb [ 1 ] \& \sim Eb [ 0 ] \& Ea [ 1 ] \& Ea [ 0 ] ) ) \vert \\ ( ( \sim Eb [ 1 ] \& \sim Eb [ 0 ] \& \sim Ea [ 1 ] \& Ea [ 0 ] ) \& \vert Ea [ msb \text{:} 2 ] ) \vert$$

$$( ( \sim Eb [ 1 ] \& \sim Eb [ 0 ] \& Ea [ 1 ] \& \sim Ea [ 0 ] ) ) ; .$$

Provided are apparatus and methods to (1) quickly determine if the exponents are consistent with a difference of one or zero, and in such a case, which exponent is larger; and (2) handle the difficult case when at least one of the operands is subnormal. When the true difference of the exponent is later determined, if the true difference turns out to be negative one, zero, or one, the speculatively executed raw difference of the mantissas is selected, otherwise, the mantissas are aligned by the difference in the exponents, but will save time downstream by virtue of requiring a normalization shift by at most one place.

In a further example, provided is a non-transitory computer-readable medium, comprising instructions stored thereon that, if executed by a processor, cause the processor to execute at least a part of the aforementioned method. The non-transitory computer-readable medium can be integrated with a device, such as abuse station, a remote unit, a mobile device, a music player, a video player, an entertainment unit, a navigation device, a communications device, a personal digital assistant (PDA), a fixed location data unit, and/or a computer.

In another example, provided is a floating point adder. The floating point adder includes means for receiving a first operand having a respective exponent, and a second operand having a respective exponent. At least one of the first operand and the second operand can be subnormal. At least one of the first operand and the second operand can be normal. The floating point adder also includes means for comparing two least significant bits (LSBs) of the first operands exponent with two LSBs of the second operand's exponent to estimate if the first operands exponent is larger than the second operands exponent (e.g., by one), the second operand's exponent is larger than the first operands exponent (e.g., by one), the first operand's exponent equals the second operand's exponent, or the first and second operands' exponents are inconsistent with a difference of one or less. Also included are means for performing a first shift of one of the first and the second operands, based on the results of the comparing, as well as means for producing a prospective result by subtracting the first operand and the second operand after the first shift. The floating point adder also includes means for subtracting all bits of one of the first operand's exponent and the second operands exponent from all bits of the other of the first operand's exponent and the second operand's exponent to determine the true exponent difference, where the subtracting is performed contemporaneously with the comparing, the performing the first shift, and the producing the prospective result. The adder further includes means for determining if the first operand's exponent and the second operand's exponent differ by one or less, and providing the prospective result as an output of the floating point adder if the first operand's exponent and the second operand's exponent differ by one or less. Also included are means for determining if the first operand's exponent and the second operand's exponent do not differ by one or less, and means for determining, from all bits of the first operand's exponent and the second operand's exponent, a second shift of one of the first and the second operands; performing the second shift of one of the first and the second operands; and subtracting the first operand and the second operand, after the second shift, to produce the raw difference of the operands, where the determining the second shift, the performing the second shift, and subtracting the first operand and the second operand are performed if the first operands exponent and the second operand's exponent do not differ by one or less. Optionally, the floating point adder can be configured such that the means for comparing and the means for performing the first shift of one of the first and the second operands are configured to perform their respective functions during a subtraction process.

Optionally, the subtraction of the two mantissas treats the mantissa with the larger exponent as the minuend and the mantissa with the smaller exponent as the subtrahend. When the exponents are equal the choice of minuend and subtrahend is arbitrary. Also, the floating point adder can include means for, if the exponents are equal and the difference of the mantissas is negative, performing a two's complement process on the difference in a downstream adder that is normally used when the exponents differ by more than one. Furthermore, the floating point adder can include means for, when the LSBs of the exponents are inconsistent with a difference of one or zero, blocking the speculative subtraction to save energy.

In an aspect, when at least one of the first operand and the second operand is subnormal, the means for performing the first shift produces relative right alignment of the first operand to the second operand by using the following equation, where “Ea” indicates the first operands exponent. “Eb” indicates the second operand's exponent, and subnormal exponents use reserved encoding of all zeros:

$$( ( \sim Eb [ 1 ] \& Ea [ 1 ] \& Ea [ 0 ] ) \vert \\ ( Eb [ 1 ] \& Eb [ 0 ] \& Ea [ 1 ] \& \sim Ea [ 0 ] ) \vert \\ ( Eb [ 1 ] \& \sim Eb [ 0 ] \& \sim Ea [ 1 ] ) ) \vert \\ ( ( \sim Eb [ 1 ] \& Eb [ 0 ] \& \sim Ea [ 1 ] \& \sim Ea [ 0 ] ) \& \vert Ea [ msb \text{:} 2 ] ) ; .$$

In a further aspect, when at least one of the first operand and the second operand is subnormal, the means for performing the first shift produces relative right alignment of the second operand to the first operand by using the following equation, where “Ea” indicates the first operands exponent, “Eb” indicates the second operand's exponent, and subnormal exponents use reserved encoding of all zeros:

$$( ( \sim Eb [ 1 ] \& Eb [ 0 ] \& Ea [ 1 ] ) \vert \\ ( Eb [ 1 ] \& Eb [ 0 ] \& \sim Ea [ 1 ] ) \vert \\ ( Eb [ 1 ] \& \sim Eb [ 0 ] \& Ea [ 1 ] \& Ea [ 0 ] ) ) \vert \\ ( ( \sim Eb [ 1 ] \& \sim Eb [ 0 ] \& \sim Ea [ 1 ] \& \sim Ea [ 0 ] ) \& \vert Ea [ msb \text{:} 2 ] ) \vert$$

$$( ( \sim Eb [ 1 ] \& \sim Eb [ 0 ] \& Ea [ 1 ] \& \sim Ea [ 0 ] ) ) ; .$$

At least a part of the floating point adder can be integrated on a semiconductor die. Further, at least a part of the floating point adder can be integrated with a device, such as a mobile device, a set top box, a music player, a video player, an entertainment unit, a navigation device, a communications device, a personal digital assistant (PDA), a fixed location data unit and/or a computer. In a farther example, provided is anon-transitory computer-readable medium, comprising instructions stored thereon that, if executed by a lithographic device, cause the lithographic device to fabricate at least a part of the floating point adder.

In another example, provided is a floating point adder comprising a processor configured to perform at least a part of the method described above. The processor can be further configured to perform the comparing and the performing the first shift of one of the first and the second operands drurin a subtraction process.

At least a part of the floating point adder can be integrated on a semiconductor die. Further, at least a part of the floating point adder can be integrated with a device, such as a mobile device, a set top box, a music player, a video player, an entertainment unit, a navigation device, a communications device, a personal digital assistant (PDA), a fixed location data unit, and/or a computer. In a further example, provided is a non-transitory computer-readable medium, comprising instructions stored thereon that, if executed by a lithographic device, cause the lithographic device to fabricate at least a part of the floating point adder.

Exemplary methods and apparatus for subtracting a first operand and a second operand in a floating point adder are provided. In an exemplary method, the first and the second operands, each of which has a respective exponent are received. At least one of the first operand and the second operand can be subnormal. At least one of the first operand and the second operand can be normal. An exponent difference of one or less between a first operand's exponent and a second operand's exponent is predicted without subtracting one of the first operand's exponent and the second operand's exponent from the other of the first operand's exponent and the second operand's exponent.

In a further example, provided is a non-transitory computer-readable medium, comprising instructions stored thereon that, if executed by a processor, cause the processor to execute at least a part of the aforementioned method. The non-transitory computer-readable medium can be integrated with a device, such as a mobile device, a music player, a video player, an entertainment unit, a navigation device, a communications device, a personal digital assistant (FDA), a fixed location data unit, and/ora computer.

In another example, provided is an apparatus configured to subtract a first operand and a second operand in a floating point adder. The apparatus includes means for receiving the first and the second operands, each of which has a respective exponent. At least one of the first operand and the second operand can be subnormal. The apparatus also includes means for predicting an exponent difference of one or less between the first operand's exponent and the second operand's exponent without subtracting one of the first operands exponent and the second operands exponent from the other of the first operand's exponent and the second operand's exponent.

At least a part of the apparatus can be integrated in a semiconductor die. Further, at least a part of the apparatus can be integrated with a device, such as a mobile device, a set top box, a music player, a video player, an entertainment unit, a navigation device, a communications device, a personal digital assistant (FDA), a fixed location data unit, and/or a computer. In a further example, provided is a non-transitory computer-readable medium, comprising instructions stored thereon that, if executed by a lithographic device, cause the lithographic device to fabricate at least a part of the apparatus.

In another example, provided is a floating point adder. The floating point adder includes a processor configured to receive first and second operands, each of which has a respective exponent. At least one of the first operand and the second operand can be subnormal. At least one of the first operand and the second operand can be normal. The processor is also configured to predict an exponent difference of one or less between the first operands exponent and the second operand's exponent without subtracting one of the first operand's exponent and the second operand's exponent from the other of the first operands exponent and the second operand's exponent.

At least a part of the apparatus can be integrated in a semiconductor die. Further, at least a part of the apparatus can be integrated with a device, such as a mobile device, a set top box, a music player, a video player, an entertainment unit, a navigation device, a communications device, a personal digital assistant (FDA), a fixed location data unit, and/or a computer. In a farther example, provided is a non-transitory computer-readable medium, comprising instructions stored thereon that, if executed by a lithographic device, cause the lithographic device to fabricate at least a part of the floating point adder.

The foregoing broadly outlines some of the features and technical advantages of the present teachings in order that the detailed description and drawings can be better understood. Additional features and advantages are also described in the detailed description. The conception and disclosed embodiments can be readily utilized as a basis for modifying or designing other structures for carrying out the same purposes of the present teachings. Such equivalent constructions do not depart from the technology of the teachings as set forth in the claims. The novel features that are characteristic of the teachings, together with further objects and advantages, are better understood from the detailed description and the accompanying figures. Each of the figures is provided for the purpose of illustration and description only, and does not limit the present teachings.

### BRIEF DESCRIPTION OF THE DRAWINGS

The accompanying drawings are presented to describe examples of the present teachings, and are not limiting.

FIG. 1 depicts an exemplary communication system in which an embodiment of the disclosure may be advantageously employed.

FIG. 2 depicts a block diagram of an apparatus for subtracting operands.

FIG. 3 depicts a flowchart of an exemplary method for subtracting operands.

FIG. 4 depicts a flowchart of an exemplary method for subtracting operands.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

### Introduction

Methods and apparatus for performing subtraction in a floating-point adder with operand shifting based on a predicted exponent difference are provided. Floating-point adders need to take as few cycles as possible to be competitive in the marketplace. Before the mantissa subtraction can be performed the operand mantissas must be aligned according to the difference of the operands exponents. Quickly determining the alignment shift amount for each operand via exponent difference prediction, should the exponent difference magnitude subsequently be determined to be one or zero, allows an early speculative limited alignment shift and subtraction which completes a significant portion of the calculation.

The exemplary apparatuses and methods disclosed, herein address the long-felt industry needs identified above, as well as other long-felt industry needs. For example, an advantage provided by the exemplary apparatuses and methods disclosed herein is an improvement in processing speed over conventional devices. Another advantage is that the adders described herein, when compared to conventional devices, save power by limiting speculative execution of subtracting in a first stage to a time when the subtraction process is more likely to need speculative execution.

The adders described herein can be used, for example, in a timer to synthesize clock waveforms. The adders can also be implemented in a processor (e.g., a central processing unit, a graphics processor, etc.), and/or a digital signal processing circuit (e.g., a digital filter). The adders can be configured to perform a mathematical function (e.g., addition, subtraction, etc.) on digital data, and can be configured to encode and/or decode a digital signal, such as a code division multiplexed signal.

Examples of the current teachings are disclosed in this application's text and drawings. The examples advantageously address the long-felt industry needs, as well as other previously unidentified needs, and mitigate shortcomings of the conventional methods and apparatus. Alternate embodiments can be devised without departing from the scope of the invention. Additionally, conventional elements of the current teachings may not be described in detail, or may be omitted, to avoid obscuring aspects of the current teachings. At least a part of an apparatus described herein can be configured to perform at least a part of a method described herein, and at least a part of a method described herein can include at least a part of a function performed by at least a part of an apparatus described herein.

In the following description, certain terminology is used to describe certain features and is not limiting. As used herein, singular forms “a,” “an,” and “the” are intended to include plural forms as well, unless the context clearly indicates otherwise. Further, the terms “comprises,” “comprising,” “includes,” and “including” specify a presence of stated features, integers, steps, operations, elements, and/or components, but do not preclude a presence and/or addition of one or more other features, integers, steps, operations, elements, components, and/or groups thereof.

Any reference herein to a feature using a designation such as “first,” “second,” and so forth does not limit a quantity and/or order of those features. Rather, these designations are used as a convenient method of distinguishing between two or more features and/or instances of a feature. Thus, a reference to first and second features does not require that only two features can be employed, or that the first feature must necessarily precede the second feature. Also, unless stated otherwise, a set of features can comprise one or more features. In addition, terminology of the form “at least one of: A, B, or C” used in the description or the claims can be interpreted as “A or B or C or any combination of these features.”

As used herein, the term “exemplary” means “serving as an example, instance, or illustration,” Any embodiment described as “exemplary” is not necessarily to be construed as preferred or advantageous over other embodiments. Likewise, the term “embodiments of the invention” does not require that all embodiments of the invention include the discussed feature, advantage, or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures.

It should be noted that the terms “connected,” “coupled,” or any variant thereof, mean any connection or coupling, either direct or indirect, between two or more elements, and can encompass a presence of one or more intermediate elements between two elements that are “connected” or “coupled” together. The coupling or connection between the elements can be physical, logical, or a combination thereof. As employed herein two elements can be considered to be “connected” or “coupled” together by the use of one or more wires, cables, and/or printed electrical connections, as well as by the use of electromagnetic energy, such as electromagnetic energy having wavelengths in the radio frequency region, the microwave region and/or the optical (both visible and invisible) region, as several non-limiting and non-exhaustive examples.

It should be understood that the term “signal” can include any signal such as a data signal, audio signal, video signal, and/or a multimedia signal. Information and signals can be represented using any of a variety of different technologies and techniques. For example, data, instructions, process step, commands, information, signals, bits, symbols, and/or chips that are referenced in this description can be represented by voltages, currents, electromagnetic waves, magnetic fields or particles, optical fields or particles, and any combination thereof.

The term “mobile device” includes, and is not limited to, a mobile phone, a mobile communication device, a terminal, a personal digital assistant, a mobile palm-held computer, a wireless device, a remote unit, other types of portable electronic devices typically carried by a person and/or having some form of communication capabilities (e.g., wireless, infrared, short-range radio, etc.), and/or any combination thereof.

The term “normal operand” includes, and is not limited to, a floating-point number with an integer bit of one and an exponent within a limited range fora given floating-point format. The term “subnormal operand” (also known as a “denormal operand”) includes, and is not limited to, a non-zero floating-point number with an integer bit of zero, and the smallest possible exponent of the limited exponent range of normal numbers. Subnormal numbers typically employ the IEEE-754-defined reserved exponent encoding of all zeros.

### DESCRIPTION OF THE FIGURES

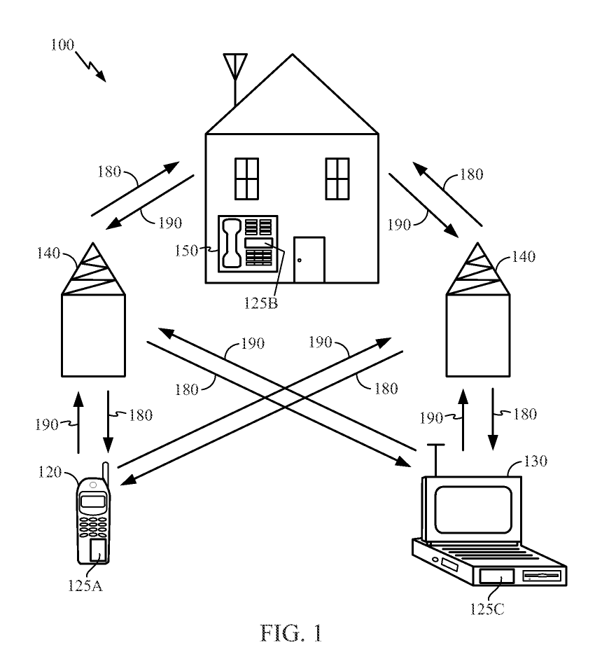

FIG. 1 depicts an exemplary communication system 100 in which an embodiment of the disclosure may be advantageously employed. For purposes of illustration. FIG. 1 shows three remote units 120, 130, and 150, as well as two base stations 140. The wireless communication system 100 can have many more remote units and/or more base stations. The remote units 120, 130, and 150 include at least a part of an embodiment 125A-C of the disclosure as discussed further herein. FIG. 1 also shows forward link signals 180 from the base stations 140 and the remote units 120, 130, and 150, as well as reverse link signals 190 from the remote units 120, 130, and 150 to the base stations 140.

In FIG. 1, the remote unit 120 is a mobile device, the remote unit 130 is a portable computer, and the remote unit 150 is a fixed location remote unit in a wireless local loop system. In examples, the remote unit 130 can be a mobile phone, a hand-held personal communication systems (PCS) unit, a portable data unit such as a personal data assistant, a GPS-enabled device, a navigation device, a settop box, a music player, a mobile device, a video player, an entertainment unit, any other device that stores and/or retrieves data or computer instructions, and/or any combination thereof. Although FIG. 1 illustrates remote units according to the teachings of the disclosure, the disclosure is not limited to these exemplary illustrated units. Embodiments of the disclosure may be suitably employed in any device that experiences the problems of the conventional techniques and/or can benefit from the advantages of the disclosed methods and devices. In a further example, processor is configured to perform at least a part of a method described herein. The processor can be integrated with at least one of the devices depicted in FIG. 1.

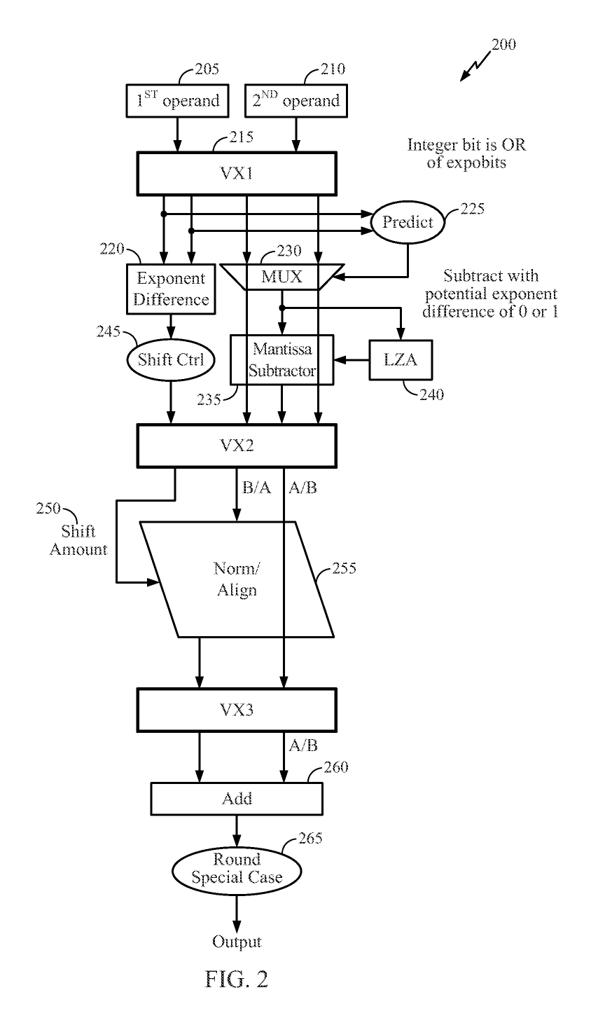

FIG. 2 depicts a block diagram of an apparatus for subtracting operands 200, including shifting an operand, in a floating point adder. When a first input operand 205 and a second input operand 210 are normal floating-point operands, the apparatus for subtracting operands 200 primarily operates on the two least significant bits (LSBs) of each of the exponents of the first input operand 205 and the second input operand 210. When either of the first input operand 205 or the second input operand 210 are subnormal operands, then the apparatus for subtracting operands 200 uses not only the two LSBs of the exponents of the first input operand 205 and the second input operand 210, but also uses the remaining bits (i.e., bits other than the two LSBs) of the respective exponents of the first input operand 205 and the second input operand 210 to resolve the subnormal case. The remaining bits can be used to a minimum extent in order to reduce processing delays and circuit complexity.

Referring to FIG. 2, the first input operand 205 and the second input operand 210, each having a respective exponent, are received at block VX1 215. An exponent difference block 220 receives the first input operand 205 and the second input operand 210, both of which include two LSBs of their respective exponents.

When the first input operand 205 and the second input operand 210 are normal floating-point operands, a predict block 225 compares the two LSBs of each of the exponents of the first input operand 205 and the second input operand 210 to estimate if the first input operand 205 has a larger exponent than the second input operand 210, the second input operand 210 has a larger exponent than the first input operand 205, or the exponent of the first input operand 205 equals the exponent of the second input operand 210. By assuming the two operands' exponents differ by zero or one, the apparatus 200 determines which of the two operands' exponents is larger, or if the two operands' exponents are equal. This is enough information to perform limited shifts with a multiplexer (mux) 230, determine an approximate normalization amount in LZA block 240, and speculatively start the subtraction operation in a Mantissa Subtractor block 235. In the exemplary apparatus 200, it is also determined if the exponents actually differ by one at the most in the exponent difference block 220. If the exponents actually differ by one at the most, the speculative subtract was correct. If the exponents do not actually differ by one at the most, then a shift control block 245 determines which operand (A or B) is to be aligned and by how much. The alignment shifting occurs in the next cycle by a shift amount 250 in a norm/align block 255. The exponent difference predict block 225, limited alignment shift in the mux 230 and the subsequent subtract in the Mantissa Subtractor block 235 can be further restricted to being performed only when a subtraction function is performed, in order to save power. Power can be farther saved in cases of subtraction by blocking this early shifting and adding to cases where the exponents are consistent with a magnitude difference of zero or one. Further detail about operand shifting can be found below.

In the case where the shift difference was zero or one, the difference from the Mantissa Subtractor block 235 is fed into the norm/align block 255 where the operand is shifted by the normalization amount determined in the LZA block 240. If this difference is negative, adder 260 is used to perform the two's complement on the operand so that the output has a pure magnitude. If the magnitude of the difference of the exponents was greater than one, the output of norm/align block 255 is fed into one input of the adder 260 and the operand that was not aligned by the norm/align block 255 is fed into the other input. The adder 260 produces only a magnitude (i.e., positive output. The round special case block 265 rounds the adder 260 output and performs a limited normalization of up to one place or forces the result in exceptional cases.

Determining which operand gets shifted also can include processing subnormal operands. The following exemplary logic tables and equations can be used to determine which operand is shifted, and a quantity of the shift. The abbreviations used herein are defined by the following key:

“Ea” indicates a first encoded exponent.

“Eb” indicates a second encoded exponent.

“A” indicates a first mantissa.

“B” indicates a second mantissa.

In an example, Table 1 indicates which operands are a minuend and a subtrahend in the shifting operation, based on the exponent relationship:

TABLE 1

| Exponent Relationship | Minuend | Subtrahend |
|---|---|---|
| Ea = Eb | A | B |
| Ea > Eb | A | B, shifted* |
| Eb > Ea | B | A, shifted* |

*Special Case: there is no shift if one exponent has an encoded value of one and the other exponent has the reserved encoded value of zero.

Table 2 indicates if the “A” operand is to be shifted right by one, based on the encoded exponent Ea and the encoded exponent Eb. In the case when Eb is 01 and Ea is 00, the shift is only performed when Ea is not subnormal; in such a case at least one of the bits in Ea must be asserted, which would give it a value greater than three.

TABLE 2

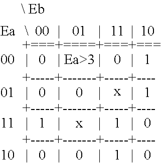

“0” = no shift
“1” = shift A
“x” = don't care
“Ea>3” = shift A only when Ea>3

The don't care space in Table 2 shows cases where the LSBs of the exponents do not have a magnitude difference of one or zero; these cases can be used to block the shifting and toggling of the downstream logic in order to save power. Furthermore, if Ea is 10 and Eb is 00 but not subnormal, this is a don't care case. Likewise, if Ea is 00 but not subnormal and Eb is 10, this is a don't care case.

Equation 1 indicates if “A” is to be shifted, based on the encoded exponent Ea and the encoded exponent Eb. A result of one indicates a right shift of “A” by one, while a zero indicates that no shift is required.

$$ShftA = ( ( \sim Eb [ 1 ] \& Ea [ 1 ] \& Ea [ 0 ] ) \vert \\ ( Eb [ 1 ] \& Eb [ 0 ] \& Ea [ 1 ] \& \sim Ea [ 0 ] ) \vert \\ ( Eb [ 1 ] \& \sim Eb [ 0 ] \& \sim Ea [ 1 ] ) ) \vert \\ ( ( \sim Eb [ 1 ] \& Eb [ 0 ] \& \sim Ea [ 1 ] \& \sim Ea [ 0 ] ) \& \vert Ea [ msb \text{:} 2 ] ) ; \\ {}_{}^{″}{msb}{}_{}^{″} = most significant bit \qquad EQUATION 1$$

The equations herein are compliant with Verilog-HDL standard: IEEE Std 1364.

Table 3 indicates if the subtrahend “B” is to be shifted, based on the encoded exponent Ea and the encoded exponent Eb. In the case when Ea is 01 and Eb is 00, the shift is only performed when Eb is not subnormal; in such a case at least one of the bits in Eb must be asserted, which would give it a value greater than three,

TABLE 3

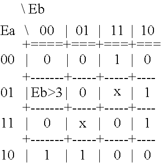

“0” = no shift
“1” = shift A
“x” = don't care
“Eb>3” = shift B only when Eb>3

As with Table 2, the don't care space in Table 3 shows cases where the LSBs of the exponents are inconsistent with them having a magnitude difference of one or zero; these cases can be used to block the shifting and toggling of the downstream logic in order to save power. Furthermore, if Ea is 10 and Eb is 00 but not subnormal, this is a don't care case. Likewise, if Ea is 00 but not subnormal and Eb is 10, this is a don't care case.

Equation 2 indicates if “B” is to be right shifted, based on the encoded exponent Ea and the encoded exponent Eb. A result of one indicates a right shift of “B” by one, while a zero indicates that no shift is required.

$$ShftB = ( ( \sim Eb [ 1 ] \& Eb [ 0 ] \& Ea [ 1 ] ) \vert \\ ( Eb [ 1 ] \& Eb [ 0 ] \& \sim Ea [ 1 ] ) \vert \\ ( Eb [ 1 ] \& \sim Eb [ 0 ] \& Ea [ 1 ] \& Ea [ 0 ] ) ) \vert \\ ( ( \sim Eb [ 1 ] \& \sim Eb [ 0 ] \& \sim Ea [ 1 ] \& Ea [ 0 ] ) \& \vert Eb [ msb \text{:} 2 ] ) \vert \\ ( ( \sim Eb [ 1 ] \& \sim Eb [ 0 ] \& Ea [ 1 ] \& \sim Ea [ 0 ] ) ) ; \qquad EQUATION 2$$

The equations herein are compliant with Verilog-HDL standard: IEEE Std 1364.

As shown in the tables and equations, the ‘00/01’ case requires special handling to support processing subnormal operands. The special handling requires using exponent bits beyond the two least significant bits (i.e., bit number two up to the most significant bit), but does not require a full subtraction of the exponents, instead, an OR-reduction of the exponent bits beyond the two lowest significant bits is performed to produce a term which can be consumed toward the end of the logic cone. This technique provides advantages of time savings and power savings over traditional techniques for determining an exponent difference of no more than one.

Table 4 depicts another example of the 00/01 case, in which one of the exponents ends with the bits “00” (e.g., 2̂00) and the other ends with the bits 01 (e.g., 2̂01). This is an example in which one exponent is subnormal, with an exponent encoded as zero (e.g., 8′b00000000), and the other is the smallest normal value (e.g., 8′b00000001). While shifting appears to be required, shilling is not required because the exponent encoding for the subnormal case doesn't reflect the true value of the biased exponent (e.g., 8′b00000001). Thus, in this example, the exponents are equal and no shifting is required.

TABLE 4

| | Expo = 0 | Expo = 0 | |
|---|---|---|---|
| | Actual | Subnormal | |
| A[1:0] = 00 | value = | Expo biased | |
| B[1:0] = 01 | 0.0 | value = 1 | Expo >3 |
| Expo = 1 | Diff > 1 | Diff = 0 | Diff > 1 |
| | Shift = x | Shift = 0 | Shift = x |
| | Answer = B | Difference = B − A | Align mantissas in the |
| | | Speculatively | Norm/Aligner |
| | | subtract | |
| Expo>4 | Diff > 1 | Diff > 1 | Diff could = 1 |
| | Shift = x | Shift = x | Shift = right by 1 |
| | Answer = B | Align mantissas in | Difference = B − |
| | | the Notm/Aligner | SHR(A,1) |
| | | | Speculatively subtract |

“x” = don't care

In the lower right corner of Table 4, where one exponent is >4 and the other exponent is >3, the exponents could differ by one. Under these circumstances, it is possible to speculatively subtract and return the normalized version of this result if it is later determined that the actual exponent difference was one.

As can be seen in Table 4, there are two circumstances which require speculative shifts. In one case, there is no shift (“A” is left as-is), and in the other case “A” is shifted to the right by one place. There are multiple methods to determine if no shift should be made, or if “A” should be shifted to the right by one. In a first method, a check is made to determine if the exponent ending in “00” is zero in all other bits. This can be performed with a logical bit-wise NOR of all of the bits, except for the two least significant bits. In a second method, a check is performed to determine if the exponent ending in “01” is zero in all other bits. This can be performed with a logical bit-wise NOR of all of the bits, except for the two least significant bits. The bit wise NORing only has to be performed on one of the exponents (either “A” or “B”). This method can be used to qualify a case where A[1:0]=00 and B[1:0]=01, or a case where A[1:0]=01 and B[1:0]=00. This saves some logical operations, and speeds up the detection of these special cases.

The special-case state determination can be made at one of two times. A first time is before the shift is performed. In other words, the shift is predicated on the determination. Making the determination before the shift requires more time, but uses fewer gates. A second time is in parallel (i.e., contemporaneous) with the subtraction. Two subtractors can each perform speculative subtraction. One subtractor first shifts “A” to the right by one, while the other subtractor performs no shifts. While subtracting, it is determined which output of the respective subtractor is to be selected. Contemporaneously determining increases circuit cost by adding leading zero anticipatory (LZA) logic, an adder, and a mux leg but reduces processing cycles. The contemporaneous determining is simpler than determining before the shift, since the LZA is only used for the shift-case, and the LZA only nee ds to look for leading zeros. As previously discussed, the LZA needs to look for leading ones in the case when the subtractor will produce a negative result.

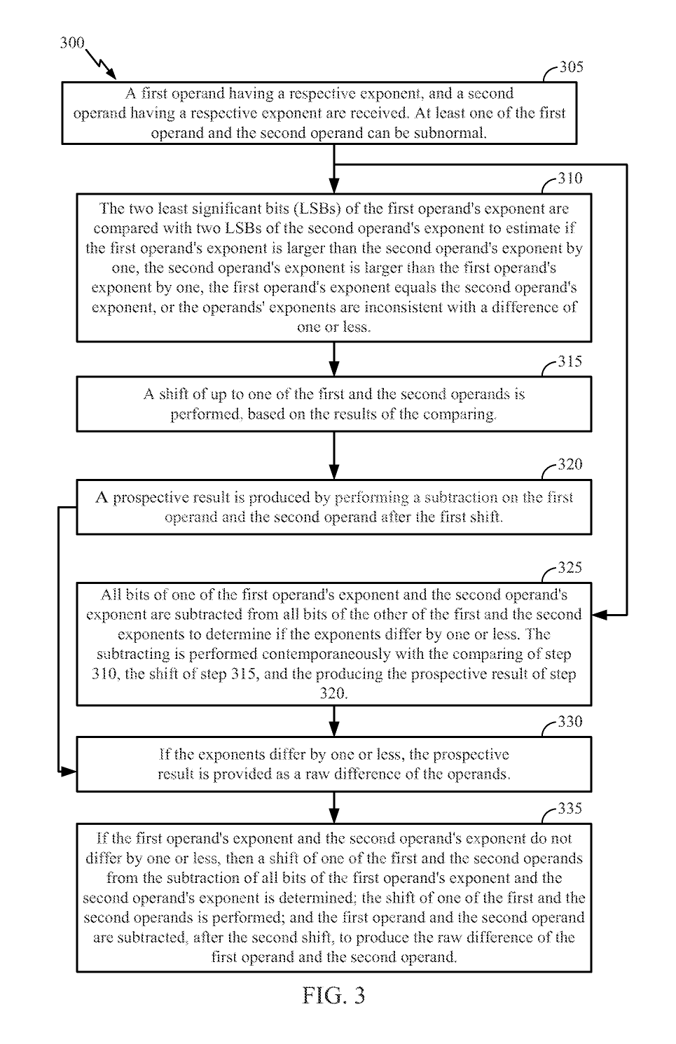

FIG. 3 depicts a flowchart of an exemplary method 300 for shifting an operand in a floating point adder. The method 300 for shifting an operand in a floating point adder can be performed by the apparatus described hereby. In examples, predicting can be substituted for the estimating described herein.

In step 305, a first operand having a respective exponent, and a second operand having a respective exponent are received. At least one of the first operand and the second operand can be subnormal. At least one of the first operand and the second operand can be normal. Step 305 can be performed by block VX1 215.

In step 310, the two least significant bits (LSBs) of the first operands exponent are compared with two LSBs of the second operand's exponent to estimate if the first operand's exponent is larger than the second operand's exponent by one, the second operands exponent is larger than the first operand's exponent by one, the first operands exponent equals the second operands exponent, or the operands are inconsistent with a difference of one or less. Optionally, step 310 is performed during a subtraction process. Further, step 310 can optionally be performed only during a subtraction process. Step 310 can be performed by the exponent difference block 220 and the predict block 225.

In step 315, up to one of the first and the second operands is shifted with a first shift, based on the results of step 310's comparing. Optionally, step 315 is performed during a subtraction process. Further, step 315 can optionally be performed only during a subtraction process. Step 315 can be performed by the mux 230. If at least one of the first operand and the second operand is subnormal, the first shift can produce relative right alignment of the first operand to the second operand by using EQUATION 1. Also, if at least one of the first operand and the second operand is subnormai the first shift can produce relative right alignment of the second operand to the first operand by using EQUATION 2.

In step 320, a prospective result is produced by subtracting the first operand and the second operand after the shift of step 315. In an example, the smaller operand is subtracted from the larger operand, where operand size is determined by the results of step 310's comparing. If step 310 results in a determination that the LSBs are consistent with substantially equal exponents, then the choice of which operand is to be subtracted is arbitrary. Step 320 can be performed by the Mantissa Subtractor block 235.

Optionally, the subtraction of the two mantissas treats the mantissa with the larger exponent as the minuend and the mantissa with the smaller exponent as the subtrahend, and when the exponents are equal the choice of minuend and subtrahend is arbitrary. Further, if the exponents are equal and the difference of the mantissas is negative, step 320 can include performing a twos complement process on the difference in a downstream adder that is normally used when the exponents differ by more than one.

Optionally, when the LSBs of the exponents are inconsistent with a difference of one or zero, the speculative subtraction in step 320 is blocked to save energy

In step 325, all bits of one of the first operand's exponent and the second operand's exponent are subtracted from all bits of the other of the first operand's exponent and the second operand's exponent to determine the true exponent difference. The subtracting of step 325 is performed contemporaneously with the comparing of step 310, the shift of step 315, and the producing the prospective result of step 320. Step 325 can be performed by the Mantissa Subtractor block 235.

In step 330, if the exponents differ by one or less, the prospective result is provided as an output of the floating point adder.

In step 335, if the first operands exponent and the second operands exponent do not differ by one or less, then a shift of one of the first operand and the second operand is performed with a second shift that is based on the true exponent difflm-ence computed in step 325. Further, the first operand and second operand are added or subtracted, after the shift, to produce a raw result. Step 335 can be performed by the norm/align block 255 and the adder 260.

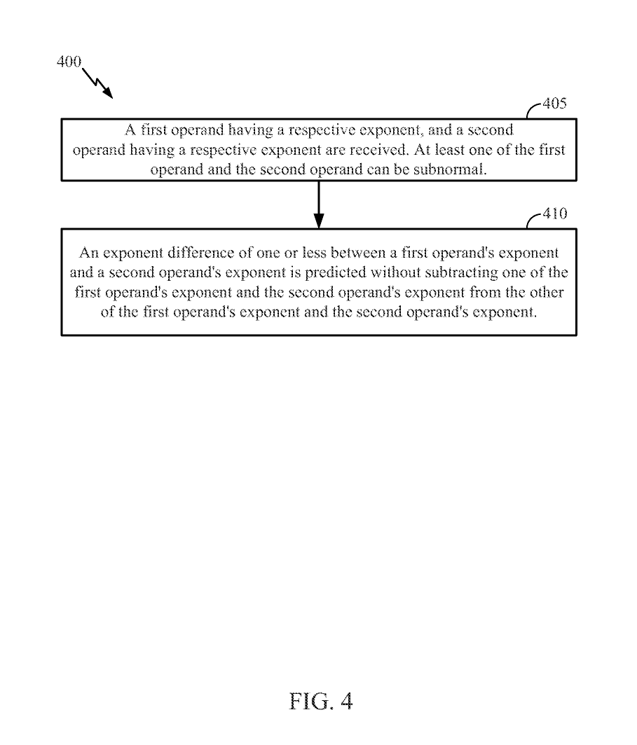

FIG. 4 depicts a flowchart of an exemplary method 400 for subtracting a first operand and a second operand in a floating point adder. The method 400 for subtracting a first operand and a second operand in a floating point adder can be performed by the apparatus described hereby.

In step 405, a first operand having a respective exponent, and a second operand having a respective exponent are received. At least one of the first operand and the second operand can be subnormal. At least one of the first operand and the second operand can be normal. Step 405 can be performed by block VX1 215 and/or the predict block 225.

In step 410, an exponent difference of one or less between a first operand's exponent and a second operand's exponent is predicted without subtracting one of the first operands exponent and the second operand's exponent from the other of the first operand's exponent and the second operands exponent. Step 410 can be performed by the predict block 225.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

In some aspects, the teachings herein can be employed in a multiple-access system capable of supporting communication with multiple users by sharing the available system resources (e.g., by specifying one or more of bandwidth, transmit power, coding, interleaving, and so on). For example, the teachings herein can be applied to any one or combinations of the following technologies: Code Division Multiple Access (CDMA) systems, Multiple-Carrier CDMA (MCCDMA), Wideband CDMA (W-CDMA), High-Speed Packet Access (HSPA, FISPA+) systems, Time Division Multiple Access (TDMA) systems. Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein can be designed to implement one or more standards, such as IS-95, cdma2000, IS-856, W-CDMA, TDSCDMA, and other standards. A CDMA network can implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein can be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure can be described using 3GPP terminology, it is to be understood that the teachings herein can be applied to 3GPP (e.g., Re199, Re15, Re16, Re17) technology, as well as 3GPP2 (e.g., 1xRTT, 1xEV-DO RelO, RevA, RevB) technology and other technologies. The techniques can be used in emerging and future networks and interfaces, including Long Term Evolution (LTE).

At least a portion of the methods, sequences and/or algorithms described in connection with the embodiments disclosed herein may be embodied directly in hardware, in a software module executed by a processor, or in a combination of the two. In an example, a processor includes multiple discrete hardware components. A software module may reside in RAM memory, flash memory, ROM memory, EPROM memory, EEPROM memory, registers, hard disk, a removable disk, a CD-ROM, and/or any other form of storage medium known in the art. An exemplary storage medium can be coupled to the processor such that the processor can read information from, and write information to, the storage medium. In an alternative, the storage medium may be integral with the processor.

Further, many embodiments are described in terms of sequences of actions to be performed by, for example, elements of a computing device. Various actions described herein can be performed by a specific circuit (e.g., an application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, a corresponding circuit of any such embodiments may be described herein as, for example, “logic configured to” perform a described action.

An embodiment of the invention can include a computer readable media embodying a method described herein. Accordingly, the invention is not limited to illustrated examples and any means for performing the functionality described herein are included in embodiments of the invention.

The disclosed devices and methods can be designed and can be configured into a computer-executable file that is in a Graphic Database System Two (GDSH) compatible format, an Open Artwork System Interchange Standard (OASIS) compatible format, and/or a GERBER (e.g., RS-274D, RS-274X, etc.) compatible format, which are stored on a computer-readable media. The file can be provided to a fabrication handler who fabricates with a lithographic device, based on the file, an integrated device. In an example, the integrated device is on a semiconductor wafer. The semiconductor wafer can be cut into a semiconductor die and packaged into a semiconductor chip. The semiconductor chip can be employed in a device described herein (e.g., a mobile device).

Embodiments can include a machine-readable media and/or a computer-readable media embodying instructions which, when executed by a processor, transform a processor and any other cooperating devices into a machine for performing a function described hereby/at least a part of the apparatus described hereby.

Nothing stated or illustrated herein is intended to cause a dedication of any component, step, feature, object, benefit, advantage, or equivalent to the public, regardless of whether the component, step, feature, object, benefit, advantage, or the equivalent is recited in the claims.

While this disclosure describes exemplary embodiments of the invention, it should be noted that various changes and modifications could be made herein without departing from the scope of the invention as defined by the appended claims.

What is claimed is:

1. A method for subtracting a first operand and a second operand in a floating point adder, comprising:
receiving:
the first operand having a respective exponent, and
the second operand having a respective exponent;
comparing two least significant bits (LSBs) of the first operands exponent with two LSBs of the second operands exponent to estimate if:
the first operand's exponent is larger than the second's operand exponent by one;
the second operand's exponent is larger than the first's operand exponent by one;
the first operand's exponent equals the second operands exponent; or
the operands exponents are inconsistent with a difference of one or less;
performing a first shift of up to one of the first and the second operands, based on the results of the comparing;
producing a prospective result by performing a subtraction on the first operand and the second operand after the first shift;
subtracting all bits of one of the first operand's exponent and the second operand's exponent from all bits of the other of the first operand's exponent and the second operand's exponent to determine if the first operand's exponent and the second operand's exponent differ by one or less, wherein the subtracting is performed contemporaneously with the comparing, the performing the first shift, and the producing the prospective result;
if the exponents differ by one or less, providing the prospective result as a raw difference of the operands; and
if the exponents do not differ by one or less, then:
determining a second shift of one of the first and the second operands from the subtraction of all bits of the first operand's exponent and the second operand's exponent;
performing the second shift of one of the first and the second operands; and
subtracting the first operand and the second operand, after the second shift, to produce the raw difference of the first operand and the second operand.

2. The method of claim 1, wherein the comparing and the performing the first shift of one of the first and the second operands occurs during the exponent subtraction process.

3. The method of claim 1, wherein when the exponents are not equal the subtraction of the two mantissas treats the mantissa with the larger exponent as the minuend and the mantissa with the smaller exponent as the subtrahend, and when the exponents are equal the choice of minuend and subtrahend is arbitrary.

4. The method of claim 3 further comprising, if the exponents are equal and the difference of the mantissas is negative, performing a two's complement process on the difference in a downstream adder that is normally used when the exponents differ by more than one.

5. The method of claim 1, wherein, when the LSBs of the exponents are inconsistent with a difference of one or zero, the speculative subtraction is blocked, to save energy.

6. A floating point adder, comprising a processor configured to perform a method comprising:
receiving:
the first operand having a respective exponent, and
the second operand having a respective exponent;
comparing two least significant bits (LSBs) of the first operands exponent with two LSBs of the second operands exponent to estimate if:
the first operand's exponent is larger than the second's operand exponent by one;
the second operand's exponent is larger than the first's operand exponent by one;
the first operand's exponent equals the second operand's exponent; or
the operands' exponents are inconsistent with a difference of one or less;
performing a first shift of up to one of the first and the second operands, based on the results of the comparing;
producing a prospective result by performing a subtraction on the first operand and the second operand after the first shift;
subtracting all bits of one of the first operand's exponent and the second operand's exponent from all bits of the other of the first operands exponent and the second operand's exponent to determine if the first operands exponent and the second operand's exponent differ by one or less, wherein the subtracting is performed contemporaneously with the comparing, the performing the first shift, and the producing the prospective result;
if the exponents differ by one or less, providing the prospective result as a raw difference of the operands; and
if the exponents do not differ by one or less, then:
determining a second shift of one of the first and the second operands from the subtraction of all bits of the first operand's exponent and the second operand's exponent;
performing the second shift of one of the first and the second operands; and
subtracting the first operand and the second operand, after the second shift, to produce the raw difference of the first operand and the second operand.

7. The floating point adder of claim 6, wherein processor is further configured to perform the comparing and the performing the first shift of one of the first and the second operands occurs during the exponent subtraction process.

8. The floating point adder of claim 6, wherein when the exponents are not equal the subtraction of the two mantissas treats the mantissa with the larger exponent as the minuend and the mantissa with the smaller exponent as the subtrahend, and when the exponents are equal the choice of minuend and subtrahend is arbitrary.

9. The floating point adder of claim 6, wherein the processor is further configured to, if the exponents are equal and the difference of the mantissas is negative, perform a two's complement process on the difference in a downstream adder that is normally used when the exponents differ by more than one.

10. The floating point adder of claim 6, wherein the processor is further configured to, when the LSBs of the exponents are inconsistent with a difference of one or zero, block the speculative subtraction to save energy.

11. The floating point adder of claim 6, wherein the processor is integrated on a semiconductor die.

12. The floating point adder of claim 6, further comprising at least one of a base station, a mobile device, and a remote unit, with which the processor is integrated.

13. A non-transitory computer-readable medium, comprising instructions stored thereon that, if executed by a processor, cause the processor to execute a method comprising:
receiving:
the first operand having: respective exponent, and
the second operand having a respective exponent;
comparing two least significant bits (LSBs) of the first operands exponent with two LSBs of the second operands exponent to estimate if:
the first operand's exponent is larger than the second's operand exponent by one;
the second operand's exponent is larger than the first's operand exponent by one;
the first operand's exponent equals the second operands exponent; or
the operands exponents are inconsistent with a difference of one or less;
performing a first shift of up to one of the first and the second operands, based on the results of the comparing;
producing a prospective result by performing a subtraction on the first operand and the second operand after the first shift;
subtracting all bits of one of the first operand's exponent and the second operands exponent from all bits of the other of the first operand's exponent and the second operand's exponent to determine if the first operand's exponent and the second operand's exponent differ by one or less, wherein the subtracting is performed contemporaneously with the comparing, the performing the first shift, and the producing the prospective result;
if the exponents differ by one or less, providing the prospective result as a raw difference of the operands; and
if the exponents do not differ by one or less, then:
determining a second shift of one of the first and the second operands from the subtraction of all bits of the first operand's exponent and the second operand's exponent;
performing the second shift of one of the first and the second operands; and
subtracting the first operand and the second operand, after the second shift, to produce the raw difference of the first operand and the second operand.

14. The non-transitory computer-readable medium of claim 13, wherein the comparing and the performing the first shift of one of the first and the second operands occurs during the exponent subtraction process.

15. The non-transitory computer-readable medium of claim 13, wherein when the exponents are not equal the subtraction of the two mantissas treats the mantissa with the larger exponent as the minuend and the mantissa with the smaller exponent as the subtrahend, and when the exponents are equal the choice of minuend and subtrahend is arbitrary.

16. The non-transitory computer-readable medium of claim 15, wherein the method farther comprises, if the exponents are equal and the difference of the mantissas is negative, performing a two's complement process on the difference in a downstream adder that is normally used when the exponents differ by more than one.

17. The non-transitory computer-readable medium of claim 13, wherein, when the LSBs of the exponents are inconsistent with a difference of one or zero, the speculative subtraction is blocked to save energy.

18. The non-transitory computer-readable medium of claim 13, further comprising at least one of a base station, a mobile device, and a remote unit, with which the computer-readable medium is integrated.

19. A floating point adder, comprising:
means for receiving:
a first operand having a respective exponent, and
a second operand having a respective exponent;
means for comparing two least significant bits (LSBs) of the first operand's exponent with two LSBs of the second operand's exponent to estimate if:
the first operand's exponent is larger than the second's operand exponent by one;
the second operand's exponent is larger than the first's operand exponent by one;
the first operand's exponent equals the second operamk exponent; or
the operands exponents are inconsistent with a difference of one or less;
means for performing a first shift of up to one of the first and the second operands, based on the results of the comparing;
means for producing a prospective result by performing a subtraction on the first operand and the second operand after the first shift;
means for subtracting all bits of one of the first operand's exponent and the second operand's exponent from all bits of the other of the first operand's exponent and the second operand's exponent to determine if the first operand's exponent and the second operand's exponent differ by one or less, wherein the subtracting is performed contemporaneously with the comparing, the performing the first shift, and the producing the prospective result;
means for determining if the exponents differ by one or less, and for providing the prospective result as a raw difference of the operands; and
means for determining if the exponents do not differ by one or less, and for then:
determining a second shift of one of the first and the second operands from the subtraction of all bits of the first operand's exponent and the second operand's exponent;
performing the second shift of one of the first and the second operands; and
subtracting the first operand and the second operand, after the second shift, to produce the raw difference of the first operand and the second operand.

20. The floating point adder of claim 19, wherein means for comparing and the means for performing the first shift of one of the first and the second operands are configured to perform their respective functions during a subtraction process.

21. The floating point adder of claim 19, wherein when the exponents are not equal the subtraction of the two mantissas treats the mantissa with the larger exponent as the minuend and the mantissa with the smaller exponent as the subtrahend, and when the exponents are equal the choice of minuend and subtrahend is arbitrary.

22. The floating point adder of claim 21, further comprising means for, if the exponents are equal and the difference of the mantissas is negative, performing a two's complement process on the difference in a downstream adder that is normally used when the exponents differ by more than one.

23. The floating point adder of claim 19, further comprising means for, when the LSBs of the exponents are inconsistent with a difference of one or zero, blocking the speculative subtraction to save energy.

24. The floating point adder of claim 19, wherein at least a part of the floating point adder is integrated on a semiconductor die.

25. The floating point adder of claim 19, further comprising at least one of a base station, a mobile device, and a remote unit, with which the floating point adder is integrated.

26. A non-transitory computer-readable medium, comprising instructions stored thereon that, if executed by a lithographic device, cause the lithographic device to fabricate at least a part of a floating point adder comprising:
a processor configured to perform a method comprising:
receiving:
a first operand having a respective exponent, and
a second operand having a respective exponent;
comparing two least significant bits (LSBs) of the first operand's exponent with two LSBs of the second operands exponent to estimate if:
the first operands exponent is larger than the seconds operand exponent by one;
the second operand's exponent is larger than the first's operand exponent by one;
the first operand's exponent equals the second operand's exponent; or
the operands exponents are inconsistent with a difference of one or less;
performing a first shift of up to one of the first and the second operands, based on the results of the comparing;
producing a prospective result by performing a subtraction on the first operand and the second operand after the first shift;
subtracting all bits of one of the first operand's exponent and the second operand's exponent from all bits of the other of the first operand's exponent and the second operand's exponent to determine if the first operand's exponent and the second operands exponent differ by one or less, wherein the subtracting is performed contemporaneously with the comparing, the performing the first shift, and the producing the prospective result;
if the exponents differ by one or less, providing the prospective result as a raw difference of the operands; and
if the exponents do not differ by one or less, then:
determining a second shift of one of the first and the second operands from the subtraction of all bits of the first operand's exponent and the second operand's exponent;
performing the second shift of one of the first and the second operands; and
subtracting the first operand and the second operand, after the second shift, to produce the raw difference of the first operand and the second operand.

27. A method for subtracting a first operand and a second operand in a floating point adder, comprising:
receiving:
the first operand having a respective exponent, and
the second operand having a respective exponent, wherein at least one of the first and the second operands is subnormal;
comparing the first operand exponent with the second operand exponent to determine if:
the first operand's exponent is larger than the second's operand exponent by one;
the second operand's exponent is larger than the first's operand exponent by one;
the first operand's exponent equals the second operand's exponent; or
the operands exponents are inconsistent with a difference of one or less;
performing a first shift of up to one of the first and the second operands, based on the results of the comparing;
producing a prospective result by performing a subtraction on the first operand and the second operand after the first shift;
subtracting all bits of one of the first operand's exponent and the second operand's exponent from all bits of the other of the first operand's exponent and the second operand's exponent to determine if the first operand's exponent and the second operand's exponent differ by one or less, wherein the subtracting is performed contemporaneously with the comparing, the performing the first shift, and the producing the prospective result;
if the exponents differ by one or less, providing the prospective result as a raw difference of the operands; and
if the exponents do not differ by one or less, then:
determining a second shift of one of the first and the second operands from the subtraction of all bits of the first operand's exponent and the second operand's exponent;
performing the second shift of one of the first and the second operands; and
subtracting the first operand and the second operand, after the second shift, to produce the raw difference of the first operand and the second operand.

28. The method of claim 27, wherein the first shift produces relative right alignment of the first operand to the second operand by using the following equation, where “Ea” indicates the first operands exponent, “Eb” indicates the second operand's exponent, and subnormal exponents use reserved encoding of all zeros;
$$( ( \sim Eb [ 1 ] \& Ea [ 1 ] \& Ea [ 0 ] ) \vert \\ ( Eb [ 1 ] \& Eb [ 0 ] \& Ea [ 1 ] \& \sim Ea [ 0 ] ) \vert \\ ( Eb [ 1 ] \& \sim Eb [ 0 ] \& \sim Ea [ 1 ] ) ) \vert \\ ( ( \sim Eb [ 1 ] \& Eb [ 0 ] \& \sim Ea [ 1 ] \& \sim Ea [ 0 ] ) \& \vert Ea [ msb \text{:} 2 ] ) .$$

29. The method of claim 27, wherein the first shift produces relative right alignment of the second operand to the first operand by using the following equation, where “Ea” indicates the first operands exponent, “Eb” indicates the second operand's exponent, and subnormal exponents use reserved encoding of all zeros:
$$( ( \sim Eb [ 1 ] \& Ea [ 0 ] \& Ea [ 1 ] ) \vert \\ ( Eb [ 1 ] \& Eb [ 0 ] \& \sim Ea [ 1 ] ) \vert \\ ( Eb [ 1 ] \& \sim Eb [ 0 ] \& Ea [ 1 ] \& Ea [ 0 ] ) ) \vert \\ ( ( \sim Eb [ 1 ] \& \sim Eb [ 0 ] \& \sim Ea [ 1 ] \& Ea [ 0 ] ) \& \vert Eb [ msb \text{:} 2 ] ) \vert$$
$$( ( \sim Eb [ 1 ] \& \sim Eb [ 0 ] \& Ea [ 1 ] \& \sim Ea [ 0 ] ) ) .$$

30. A floating point adder for subtracting a first operand and a second operand comprising a processor configured to perform a method comprising:
receiving:
the first operand having a respective exponent, and
the second operand having a respective exponent, wherein at least one of the first and the second operands is subnormal;
comparing the first operand exponent with the second operand exponent to determine if:
the first operand's exponent is larger than the second's operand exponent by one;
the second operand's exponent is larger than the first's operand exponent by one;
the first operand's exponent equals the second operand's exponent; or
the operands' exponents are inconsistent with a difference of one or less;
performing a first shift of up to one of the first and the second operands, based on the results of the comparing;
producing a prospective result by performing a subtraction on the first operand and the second operand after the first shift;
subtracting all bits of one of the first operand's exponent and the second operand's exponent from all bits of the other of the first operand's exponent and the second operand's exponent to determine if the first operand's exponent and the second operand's exponent differ by one or less, wherein the subtracting is performed contemporaneously with the comparing, the performing the first shift, and the producing the prospective result;
if the exponents differ by one or less, providing the prospective result as a raw difference of the operands; and
if the exponents do not differ by one or less, then:
determining a second shift of one of the first and the second operands from the subtraction of all bits of the first operand's exponent and the second operand's exponent;
performing the second shift of one of the first and the second operands; and
subtracting the first operand and the second operand, after the second shift, to produce the raw difference of the first operand and the second operand.

31. The floating point adder of claim 30, wherein the first shift produces relative right alignment of the first operand to the second operand by using the following equation, where “Ea” indicates the first operand's exponent, “Eb” indicates the second operand's exponent, and subnormal exponents use reserved encoding of all zeros:
$$( ( \sim Eb [ 1 ] \& Ea [ 1 ] \& Ea [ 0 ] ) \vert \\ ( Eb [ 1 ] \& Eb [ 0 ] \& Ea [ 1 ] \& \sim Ea [ 0 ] ) \vert \\ ( Eb [ 1 ] \& \sim Eb [ 0 ] \& \sim Ea [ 1 ] ) ) \vert \\ ( ( \sim Eb [ 1 ] \& Eb [ 0 ] \& \sim Ea [ 1 ] \& \sim Ea [ 0 ] ) \& \vert Ea [ msb \text{:} 2 ] ) .$$

32. The floating point adder of claim 30, wherein the first shift produces relative right alignment of the second operand to the first operand by using the following equation, where “Ea” indicates the first operand's exponent, “Eb” indicates the second operand's exponent, and subnormal exponents use reserved encoding of all zeros:
$$( ( \sim Eb [ 1 ] \& Eb [ 0 ] \& Ea [ 1 ] ) \vert \\ ( Eb [ 1 ] \& Eb [ 0 ] \& \sim Ea [ 1 ] ) \vert \\ ( Eb [ 1 ] \& \sim Eb [ 0 ] \& Ea [ 1 ] \& Ea [ 0 ] ) ) \vert \\ ( ( \sim Eb [ 1 ] \& \sim Eb [ 0 ] \& \sim Ea [ 1 ] \& Ea [ 0 ] ) \& \vert Eb [ msb \text{:} 2 ] ) \vert$$
$$( ( \sim Eb [ 1 ] \& \sim Eb [ 0 ] \& Ea [ 1 ] \& \sim Ea [ 0 ] ) ) .$$

33. The floating point adder of claim 30, wherein the processor is integrated on a semiconductor die.

34. The floating point adder of claim 30, further comprising at least one of a base station, a mobile device, and a remote unit, with which the processor is integrated.

35. A non-transitory computer-readable medium, comprising instructions stored thereon that, if executed by a processor, cause the processor to execute a method comprising:
receiving:
a first operand having a respective exponent, and
a second operand having a respective exponent, wherein at least one of the first and the second operands is subnormal;
comparing the first operand exponent with the second operand exponent to determine if:
the first operand's exponent is larger than the second's operand exponent by one;
the second operand's exponent is larger than the first's operand exponent by one;
the first operand's exponent equals the second operand's exponent; or
the operands exponents are inconsistent with a difference of one or less;
performing a first shift of up to one of the first and the second operands, based on the results of the comparing;
producing a prospective result by performing a subtraction on the first operand and the second operand after the first shift;
subtracting all bits of one of the first operand's exponent and the second operand's exponent from all bits of the other of the first operand's exponent and the second operands exponent to determine if the first operand's exponent and the second operand's exponent differ by one or less, wherein the subtracting is performed contemporaneously with the comparing, the performing the first shift, and the producing the prospective result;
if the exponents differ by one or less, providing the prospective result as a raw difference of the operands; and
if the exponents do not differ by one or less, then;
determining a second shift of one of the first and the second operands from the subtraction of all bits of the first operand's exponent and the second operand's exponent;
performing the second shift of one of the first and the second operands; and
subtracting the first operand and the second operand, after the second shift, to produce the raw difference of the first operand and the second operand.

36. The non-transitory computer-readable medium of claim 35, wherein the first shift produces relative right alignment of the first operand to the second operand by using the following equation, where “Ea” indicates the first operand's exponent, “Eb” indicates the second operand's exponent, and subnormal exponents use reserved encoding of all zeros:
$$( ( \sim Eb [ 1 ] \& Ea [ 1 ] \& Ea [ 0 ] ) \vert \\ ( Eb [ 1 ] \& Eb [ 0 ] \& Ea [ 1 ] \& \sim Ea [ 0 ] ) \vert \\ ( Eb [ 1 ] \& \sim Eb [ 0 ] \& \sim Ea [ 1 ] ) ) \vert \\ ( ( \sim Eb [ 1 ] \& Eb [ 0 ] \& \sim Ea [ 1 ] \& \sim Ea [ 0 ] ) \& \vert Ea [ msb \text{:} 2 ] ) .$$

37. The non-transitory computer-readable medium of claim 35, wherein the first shift produces relative right alignment of the second operand to the first operand by using the following equation, where “Ea” indicates the first operand's exponent, “Eb” indicates the second operand's exponent, and subnormal exponents use reserved encoding of all zeros:
$$( ( \sim Eb [ 1 ] \& Eb [ 0 ] \& Ea [ 1 ] ) \vert \\ ( Eb [ 1 ] \& Eb [ 0 ] \& \sim Ea [ 1 ] ) \vert \\ ( Eb [ 1 ] \& \sim Eb [ 0 ] \& Ea [ 1 ] \& Ea [ 0 ] ) ) \vert \\ ( ( \sim Eb [ 1 ] \& \sim Eb [ 0 ] \& \sim Ea [ 1 ] \& Ea [ 0 ] ) \& \vert Eb [ msb \text{:} 2 ] ) \vert$$
$$( ( \sim Eb [ 1 ] \& \sim Eb [ 0 ] \& Ea [ 1 ] \& \sim Ea [ 0 ] ) ) .$$

38. A floating point adder, comprising:
means for receiving:
a first operand having a respective exponent, and
a second operand having a respective exponent, wherein at least one of the first and the second operands is subnormal;
means for comparing the first operand exponent with the second operand exponent to determine if:
the first operand's exponent is larger than the second's operand exponent by one;
the second operand's exponent is larger than the first's operand exponent by one;
the first operand's exponent equals the second operand's exponent; or
the operands' exponents are inconsistent with a difference of one or less;
means for performing a first shift of up to one of the first and the second operands, based on the results of the comparing;
means for producing a prospective result by performing a subtraction on the first operand and the second operand after the first shift;
means for subtracting all bits of one of the first operand's exponent and the second operand's exponent from all bits of the other of the first operands exponent and the second operand's exponent to determine if the first operand's exponent and the second operand's exponent differ by one or less, wherein the subtracting is performed contemporaneously with the comparing, the performing the first shift, and the producing the prospective result;
means for determining if the exponents differ by one or less, and for providing the prospective result as a raw difference of the operands; and
means for determining if the exponents do not differ by one or less, and for then:
determining a second shift of one of the first and the second operands from the subtraction of all bits of the first operand's exponent and the second operand's exponent;
performing the second shift of one of the first and the second operands; and
subtracting the first operand and the second operand, after the second shift, to produce the raw difference of the first operand and the second operand.

39. The floating point adder of claim 38, wherein the means for performing the first shift is configured to produce relative right alignment of the first operand to the second operand by using the following equation, where “Ea” indicates the first operands exponent, “Eb” indicates the second operand's exponent, and subnormal exponents use reserved encoding of all zeros:
$$( ( \sim Eb [ 1 ] \& Ea [ 1 ] \& Ea [ 0 ] ) \vert \\ ( Eb [ 1 ] \& Eb [ 0 ] \& Ea [ 1 ] \& \sim Ea [ 0 ] ) \vert \\ ( Eb [ 1 ] \& \sim Eb [ 0 ] \& \sim Ea [ 1 ] ) ) \vert \\ ( ( \sim Eb [ 1 ] \& Eb [ 0 ] \& \sim Ea [ 1 ] \& \sim Ea [ 0 ] ) \& \vert Ea [ msb \text{:} 2 ] ) .$$

40. The floating point adder of claim 38, wherein the means for performing the first shift is configured to produce relative right alignment of the second operand to the first operand by using the following equation, where “Ea” indicates the first operands exponent, “Eb” indicates the second operand's exponent, and subnormal exponents use reserved encoding of all zeros:
$$( ( \sim Eb [ 1 ] \& Eb [ 0 ] \& Ea [ 1 ] ) \vert \\ ( Eb [ 1 ] \& Eb [ 0 ] \& \sim Ea [ 1 ] ) \vert \\ ( Eb [ 1 ] \& \sim Eb [ 0 ] \& \sim Ea [ 1 ] \& Ea [ 0 ] ) ) \vert \\ ( ( \sim Eb [ 1 ] \& \sim Eb [ 0 ] \& \sim Ea [ 1 ] \& Ea [ 0 ] ) \& \vert Eb [ msb \text{:} 2 ] ) \vert$$
$$( ( \sim Eb [ 1 ] \& \sim Eb [ 0 ] \& Ea [ 1 ] \& \sim Ea [ 0 ] ) ) .$$

41. The floating point adder of claim 38, wherein the means for receiving is integrated on a semiconductor die.

42. The floating point adder of claim 38, further comprising at least one of a base station, a mobile device, and a remote unit, with which the means for receiving is integrated.

43. A non-transitory computer-readable medium, comprising instructions stored thereon that, if executed by a lithographic device, cause the lithographic device to fabricate at least a part of a floating point adder that comprises a processor configured to perform a method comprising:
receiving:
a first operand having a respective exponent, and
a second operand having a respective exponent, wherein at least one of the first and the second operands is subnormal;
comparing the first operand exponent with the second operand exponent to determine if:
the first operand's exponent is larger than the second's operand exponent by one;
the second operand's exponent is larger than the first's operand exponent by one;
the first operand's exponent equals the second operand's exponent; or
the operands' exponents are inconsistent with a difference of one or less;
performing a first shift of up to one of the first and the second operands, based on the results of the comparing;
producing a prospective result by performing a subtraction on the first operand and the second operand after the first shift;
subtracting all bits of one of the first operand's exponent and the second operand's exponent from all bits of the other of the first operand's exponent and the second operand's exponent to determine if the first operand's exponent and the second operand's exponent differ by one or less, wherein the subtracting is performed contemporaneously with the comparing, the performing the first shift, and the producing the prospective result;
exponents differ by one or less, providing the prospective result as a raw difference of the operands; and
if the exponents do not differ by one or less, then:
determining a second shift of one of the first and the second operands from the subtraction of all bits of the first operand's exponent and the second operand's exponent;
performing the second shift of one the first and the second operands; and
subtracting the first operand and the second operand, after the second shift, to produce the raw difference of the first operand and the second operand.

44. A method for subtracting a first operand and a second operand in a floating point adder, comprising predicting an exponent difference of one or less between a first operand's exponent and a second operand's exponent without subtracting one of the first operand's exponent and the second operand's exponent from the other of the first operand's exponent and the second operand's exponent.

45. A floating point adder, comprising a processor configured to predict an exponent difference of one or less between a first operand's exponent and a second operand's exponent without subtracting one of the first operands exponent and the second operand's exponent from the other of the first operand's exponent and the second operand's exponent.

46. A non-transitory computer-readable medium, comprising instructions stored thereon that, if executed by a processor, cause the processor to execute a method comprising predicting an exponent difference of one or less between a first operand's exponent and a second operand's exponent without subtracting one of the first operand's exponent and the second operand's exponent from the other of the first operand's exponent and the second operand's exponent.

47. A floating point adder, comprising means for predicting an exponent difference of one or less between a first operand's exponent and a second operand's exponent without subtracting one of the first operand's exponent and the second operand's exponent from the other of the first operand's exponent and the second operand's exponent.

48. A non-transitory computer-readable medium, comprising instructions stored thereon that, if executed by a lithographic device, cause the lithographic device to fabricate at least a part of a floating point adder that comprises means for predicting an exponent difference of one or less between a first operand's exponent and a second operand's exponent without subtracting one of the first operand's exponent and the second operand's exponent from the other of the first operand's exponent and the second operand's exponent.
